(19) United States
(12) Patent Application Publication
(10) Pub. No.: US 2020/0272036 A1
(43) Pub. Date: Aug. 27, 2020

(54) PROJECTOR

(71) Applicants: BenQ Intelligent Technology (Shanghai) Co., Ltd, Shanghai (CN); BENQ CORPORATION, Taipei (TW)

(72) Inventors: Yung-Shun CHENG, Taipei City (TW); Chun-Min KO, New Taipei City (TW); Yu-Ming HSU, Taipei City (TW); Wen-Ming WU, New Taipei City (TW)

(73) Assignees: BenQ Intelligent Technology (Shanghai) Co., Ltd, Shanghai (CN); BENQ CORPORATION, Taipei (TW)

(21) Appl. No.: 16/795,662

(22) Filed: Feb. 20, 2020

(30) Foreign Application Priority Data
Feb. 21, 2019 (CN) 201910129463.0

(51) Int. Cl. G03B 21/14

(52) U.S. Cl. CPC G03B 21/145

(57) ABSTRACT

A projector including a projector body and a positioning member is provided. The projector body is used to project a picture. The positioning member is slidably disposed on the projector body and has a scale used to keep the projector body and the projection target at a predetermined distance. The projector body projects a picture with a specific size according to the predetermined distance.

This application claims the benefit of People's Republic of China application Serial No. 201910129463.0, filed on Feb. 21, 2019, the subject matter of which is incorporated herein by reference.

### BACKGROUND OF THE INVENTION

### Field of the Invention

The invention relates in general to a projector, and more particularly to a projector having scales.

### Description of the Related Art

The picture size projected on a screen by a conventional projector depends on the distance between the projector and the screen. Since the distance between the projector and the screen is normally gauged and adjusted by the user, the picture size projected on the screen by the projector may not meet the user's expectation. Therefore, it has become a prominent task for the industries to provide a projector capable of resolving the above problems encountered in the prior art.

### SUMMARY OF THE INVENTION

The invention relates to a projector capable of resolving the above problems encountered in the prior art.

According to an embodiment of the present invention, a projector is provided. The projector includes a projector body and a first positioning member. The projector body is used to project a picture. The first positioning member is slidably disposed on the projector body and has a first scale used to keep the projector body and a projection target at a first predetermined distance. The projector body projects a picture with a first size according to the first predetermined distance.

The above and other aspects of the invention will become better understood with regards to the following detailed description of the preferred but non-limiting embodiment (s). The following description is made with reference to the accompanying drawings.

### BRIEF DESCRIPTION OF THE DRAWINGS

FIG. 1 is a schematic diagram of a first positioning member and a second positioning member of a projector according to an embodiment of the invention at a close state.

FIG. 2 is a schematic diagram of the first positioning member and the second positioning member of the projector 100 of FIG. 1 at a protruded state.

FIG. 3 is a top view of the projector of FIG. 2 (when the sliding cover slides out).

FIG. 4 is a schematic diagram of the first positioning member and the second positioning member of the projector of FIG. 2 leaning on a projection target.

FIG. 5 is a schematic diagram of a projector according to another embodiment of the invention.

FIG. 6 is a schematic diagram of a projector according to another embodiment of the invention.

FIG. 7 is a schematic diagram of a projector according to another embodiment of the invention.

### DETAILED DESCRIPTION OF THE INVENTION

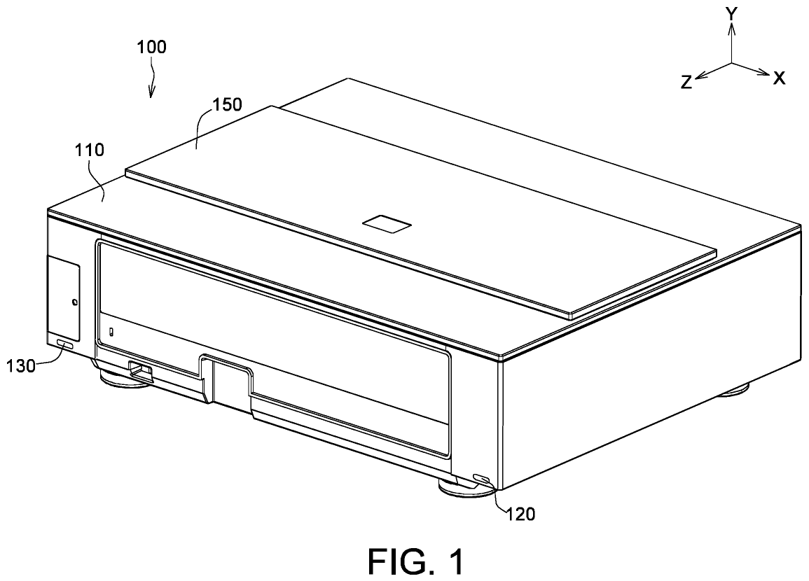

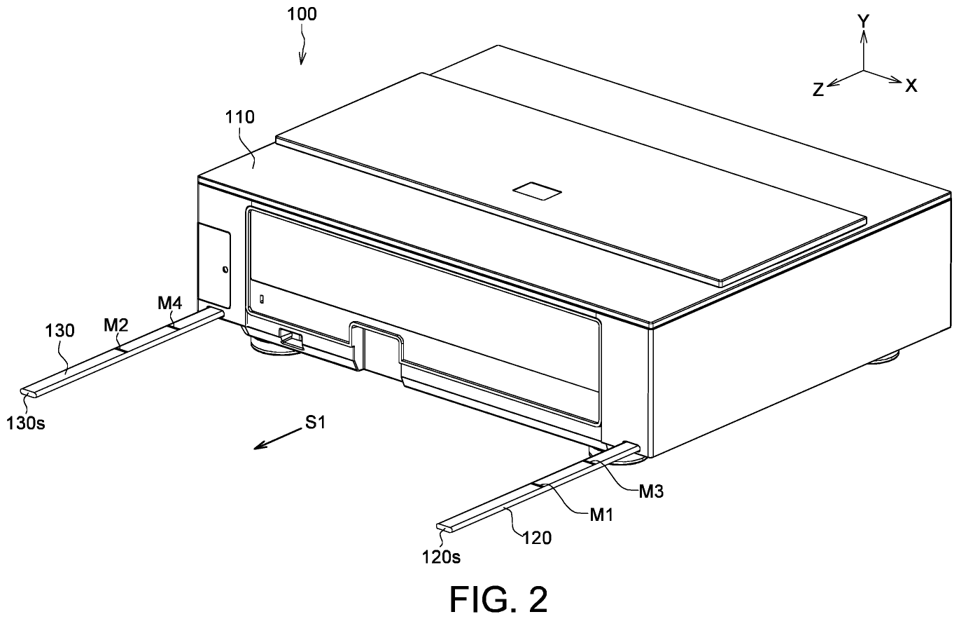

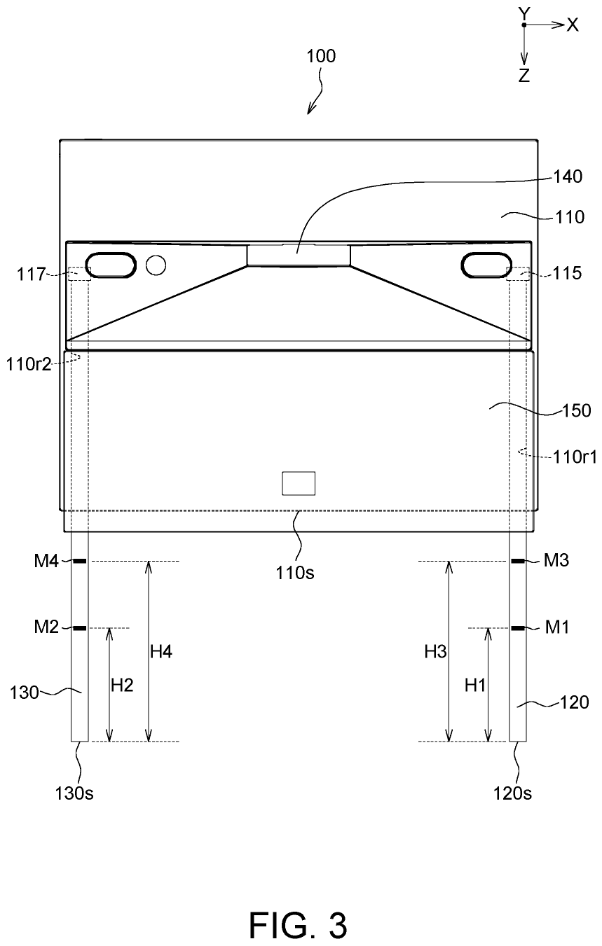

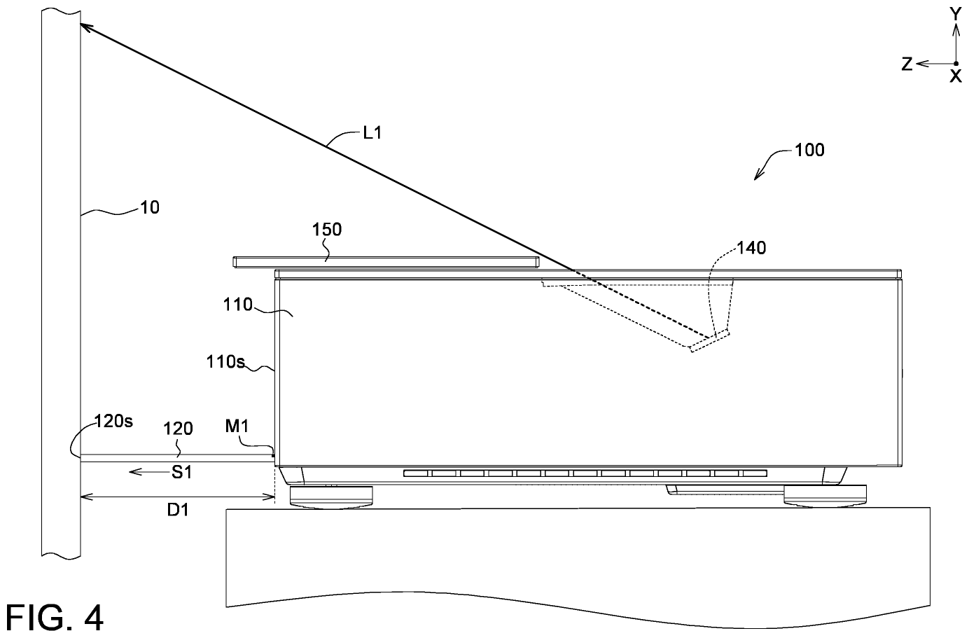

Refer to FIGS. 1 to 4. FIG. 1 is a schematic diagram of a first positioning member 120 and a second positioning member 130 of a projector 100 according to an embodiment of the invention at a close state. FIG. 2 is a schematic diagram of the first positioning member 120 and the second positioning member 130 of the projector 100 100 of FIG. 1 at a protruded state. FIG. 3 is a top view of the projector 100 of FIG. 2 (when the sliding cover slides out). FIG. 4 is a schematic diagram of the first positioning member 120 and the second positioning member 130 of the projector 100 of FIG. 2 leaning on a projection target 10.

The projector 100 includes a projector body 110, a first positioning member 120, a second positioning member 130, a projection lens 140 and a sliding cover 150. The projector body 110 further includes a light source (not illustrated) and an optical module (not illustrated). The light source emits a light which passes through the optical module and the projection lens 140 and then projects an image light L1. The image light L1 is projected on the projection target 10 to form a picture (not illustrated). As indicated in FIGS. 1 and 4, the sliding cover 150 is slidably disposed on the projector body 110. As indicated in FIG. 1, when the projector 100 is not in use (for example, at a received state), the sliding cover 150 covers the projection lens 140. As indicated in FIGS. 3 and 4, when the projector 100 is at a projection state, the sliding cover 150 slides forwards to expose the projection lens 140 and causes the image light L1 projected by the projection lens 140 to be forwardly projected on the projection target 10.

The first positioning member 120 is slidably disposed on the projector body 110 and has at least one scale, such as a first scale M1 and a third scale M3. As indicated in FIG. 4, the first scale M1 is used to keep the projector body 110 and the projection target 10 at a first predetermined distance D1. The projector body 110 projects a picture (not illustrated) with a first size according to the first predetermined distance D1. The projection target 10 can be a projection screen, a wall or an object allowing the image light projected by the projector 100 to form an image. In the present embodiment, actual dimension of the first predetermined distance D1 depends on the design of the projector body 110 and/or the first size, and is not subjected to specific restrictions in the invention.

As indicated in FIG. 4, the extending direction S1 of the first positioning member 120 and the projection direction of the projector body 110 (for example, facing the projection target 10) are substantially co-directional. The first positioning member 120 can slide relative to the projector body 110 and cause the first scale M1 to be aligned with the body surface 110s of the projector body 110, wherein the body surface 110 faces substantially the same direction with the projection direction of the projector body 110, for example, faces the front of the body surface 110. Under such circumstance, the projector 100 can define the first predetermined distance D1 using the first scale M1 to project the picture with the first size on the projection target 10. As indicated in FIG. 4, the first positioning member 120 has a first terminal surface 120s. When the first terminal surface 120s is aligned with the projection target 10, for example, the first terminal surface 120s leans on the projection target 10, the distance H1 between the first terminal surface 120s and the first scale M1 is substantially equivalent to the first predetermined distance D1 and causes the projector body 110 to project the picture with the first size on the projection target 10. In embodiment, the first terminal surface 120s can be a planar surface, a curved surface (convex surface or concave surface) or a combination thereof, which matches the surface shape of the projection target 10.

As indicated in FIG. 2, the second positioning member 130, like the first positioning member 120, is slidably disposed on the projector body 110 and has at least one scale, such as a second scale M2 and a fourth scale M4. The second scale M2 is used to keep the projector body 110 and the projection target 10 at the first predetermined distance D1 (the first predetermined distance D1 is illustrated in FIG. 4). The extending direction S1 of the second positioning member 130 and the projection direction of the projector body 110 (for example, towards the projection target 10) are substantially co-directional. The second positioning member 130 can slide relative to the projector body 110 and cause the second scale M2 to be aligned with the body surface 110s of the projector body 110. Under such circumstance, the projector 100 can define the first predetermined distance D1 using the second scale M2 to project the picture with the first size. As indicated in FIG. 3, the second positioning member 130 has a second terminal surface 130s. When the second terminal surface 130s is aligned with the projection target 10, for example, the second terminal surface 130s leans on the projection target 10, the distance H2 between the second terminal surface 130s and the second scale M2 is substantially equivalent to the first predetermined distance D1 and causes the projector body 110 to project the picture with the first size on the projection target 10.

In an embodiment, the distance H1 between the first terminal surface 120s and the first scale M1 is substantially equivalent to the distance H2 between the second terminal surface 130s and the second scale M2. Thus, when the first scale M1 and the second scale M2 both are aligned with the body surface 110s, the first terminal surface 120s and the second terminal surface 130s can concurrently lean on the projection target 10. Thus, the projector 100 leans on the projection target 10 by two positioning points (such as the first terminal surface 120s and the second terminal surface 130s), and can define the first predetermined distance D1 between the projector 100 and the projection target 10 more quickly and more stably.

In an embodiment, the first positioning member 120 and the second positioning member 130 are symmetric with respect to the middle position of the projector body 110. Thus, when the first positioning member 120 and the second positioning member 130 lean on the projection target 10, the body surface 110s of the projector body 110 is substantially parallel to the projection target 10 and causes the image light (not illustrated) projected by the projector body 110 to be correctly (non-skewedly) projected on the projection target 10. In another embodiment, the projector 100 can omit the second positioning member 130. In the present example, the first positioning member 120 is substantially located at the middle of the projector body 110.

As indicated in FIGS. 2 and 3, the first positioning member 120 further has a third scale M3 used to keep the projector body 110 and the projection target 101 at a second predetermined distance (not illustrated). The projector body 110 projects a picture with a second size according to the second predetermined distance, wherein the second size is different from the first size. In the present embodiment as indicated in FIG. 3, since the distance H1 between the first scale M1 and the first terminal surface 120s is shorter than the distance H3 between the third scale M3 and the first terminal surface 120s, the picture size (that is, the second size) projected according to the second predetermined distance can be larger than the picture size (that is, the first size) projected according to the first predetermined distance. In the present embodiment, actual dimension of the second predetermined distance depends on the design of the projector body 110 and/or the second size, and is not subjected to specific restrictions in the invention.

In an embodiment, when the distance H1 is 119 millimeters, the picture size of the projected picture is such as 80 inches; when the distance H1 is 170 millimeters, the picture size of the projected picture is such as 90 inches; when the distance H1 is 225 millimeters, the picture size of the projected picture is such as 100 inches; when the distance H1 is 321 millimeters, the picture size of the projected picture is such as 120 inches. However, the embodiments of the invention are not limited thereto. Besides, in the specification, the “picture size” refers the diagonal length of the picture projected on the projection target 10.

As indicated in FIG. 2, the second positioning member 130 further has a fourth scale M4 used to keep the projector body 110 and the projection target 10 at the second predetermined distance (not illustrated). The extending direction S1 of the second positioning member 130 and the projection direction of the projector body 110 are substantially co-directional. The second positioning member 130 can slide relative to the projector body 110 and cause the fourth scale M4 to be aligned with the body surface 110s of the projector body 110. Under such circumstance, the projector 100 can define the second predetermined distance using the fourth scale M4 to project the picture with the second size. As indicated in FIG. 3, the second positioning member 130 has the second terminal surface 130s. When the second terminal surface 130s is aligned with the projection target 10, for example, the second terminal surface 130s leans on the projection target 10, the distance H4 between the second terminal surface 130s and the fourth scale M4 is substantially equivalent to the second predetermined distance and causes the projector body 110 to project the picture with the second size on the projection target 10.

In an embodiment as indicated in FIG. 3, the distance H3 between the first terminal surface 120s and the third scale M3 is substantially equivalent to the distance H4 between the second terminal surface 130s and the fourth scale M4. Thus, when the third scale M3 and the fourth scale M4 both are aligned with the body surface 110s, the first terminal surface 120s and the second terminal surface 130s can concurrently lean on the projection target 10. Thus, the projector 100 leans on the projection target 10 by two positioning points (such as the first terminal surface 120s and the second terminal surface 130s), and can define the second predetermined distance between the projector 100 and the projection target 10 more quickly and more stably.

As indicated in FIG. 3, the projector body 110 further has a first chute 110r1 and a second chute 110r2. The first chute 110r1 and the second chute 110r2 are extended into the projector body 110 from the body surface 110s. The first positioning member 120 and the second positioning member 130 are slidably disposed on the first chute 110r1 and the second chute 110r2 respectively. When the first positioning member 120 and the second positioning member 130 are at the close state (as indicated in FIG. 1), the first positioning member 120 and the second positioning member 130 are received in the first chute 110r1 and the second chute 110r2, such that the overall volume and size of the folded projector 100 can be reduced and the receivability of the projector 100 can be increased. In an embodiment, when the first positioning member 120 and the second positioning member 130 are at the close state, the first terminal surface 120s of the first positioning member 120 and the second terminal surface 130s of the second positioning member 130 are substantially aligned, such as flush, with the body surface 110s. Thus, the first terminal surface 120s of the first positioning member 120 and the second terminal surface 130s of the second positioning member 130 will not be protruded relative to the body surface 110s.

As indicated in FIG. 3, the projector 100 further includes a first push-push mechanism 115 and a second push-push mechanism 117. The first push-push mechanism 115 and the second push-push mechanism 117 are disposed in and the projector body 110 and respectively connected to the first positioning member 120 and the second positioning member 130. When the first positioning member 120 is at the close state, the first push-push mechanism 115 is coupled with the first positioning member 120 to avoid the first positioning member 120 easily sliding relative to the projector body 110. When the first positioning member 120 at the close state is pressed, the coupling relationship between the first push-push mechanism 115 and the first positioning member 120 is released and the first positioning member 120 is ejected relative to the projector body 110 and is at a slidable state relative to the projector body 110. The connection and actuation relationship between second positioning member 130 and the second push-push mechanism 117 are similar or identical to that between the first positioning member 120 and the first push-push mechanism 115, and the similarities are not repeated here.

In the present embodiment, the amount of predetermined distances defined by the projector 100 is exemplified by 2 (the first and the second predetermined distance) for an exemplary purpose, not for limiting the embodiments of the invention. Besides, the amount of predetermined distances defined by the projector 100 depends on the amount of scales, and is not subjected to specific restrictions in the embodiments of the invention. The more scales the projector 100 has, the more levels the predetermined distance has, and the projector 100 can project several pictures with different sizes according to the predetermined distances.

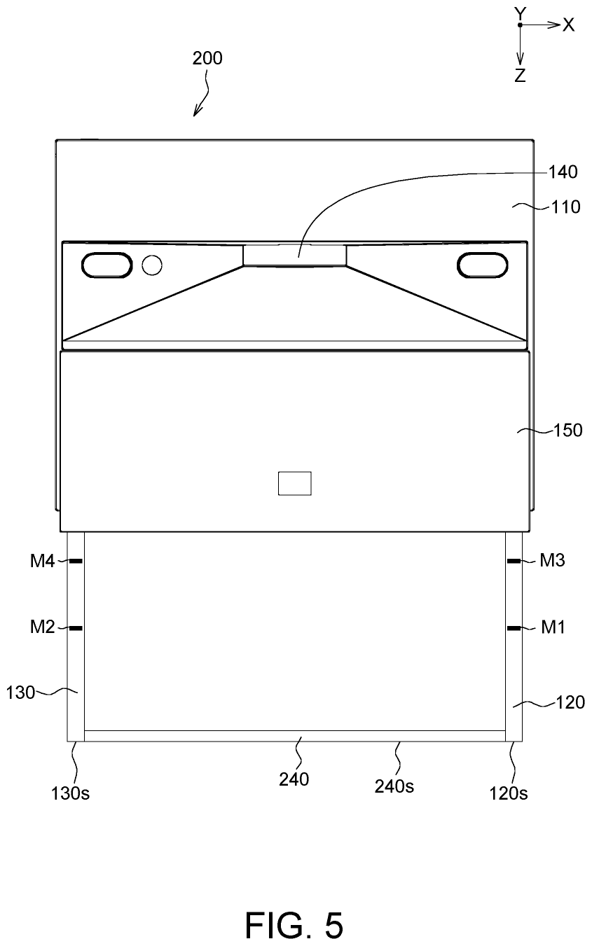

Referring to FIG. 5, a schematic diagram of a projector 200 according to another embodiment of the invention is shown. The projector 200 includes a projector body 110, a first positioning member 120, a second positioning member 130, a connecting member 240, a projection lens 140 and a sliding cover 150. The projector 200 has technical features similar or identical to that of the projector 100 except for that the connecting member 240 of the projector 200 connects the first positioning member 120 and the second positioning member 130. Since the first positioning member 120 and the second positioning member 130 are connected through the connecting member 240, the first positioning member 120, the second positioning member 130 and the connecting member 240 form an integral structure, and the first positioning member 120 and the second positioning member 130 are geared. In an embodiment, the first positioning member 120, the second positioning member 130 and the connecting member 240 can be integrally formed in one piece by the same manufacturing process.

As indicated in FIG. 5, the first positioning member 120 has a first terminal surface 120s, the second positioning member 130 has a second terminal surface 130s, and the connecting member 240 has a third terminal surface 240s, wherein the first terminal surface 120s and the second terminal surface 130s are substantially aligned, such as flush, with the third terminal surface 240s. Thus, the first terminal surface 120s, the second terminal surface 130s and the third terminal surface 240s can concurrently lean on the projection target 10 and the projector 100 can lean on the projection target 10 more stably.

Moreover, the features and/or connection relationship of other elements of the projector 200 are similar or identical that corresponding features of the projector 100, and the similarities are not repeated here.

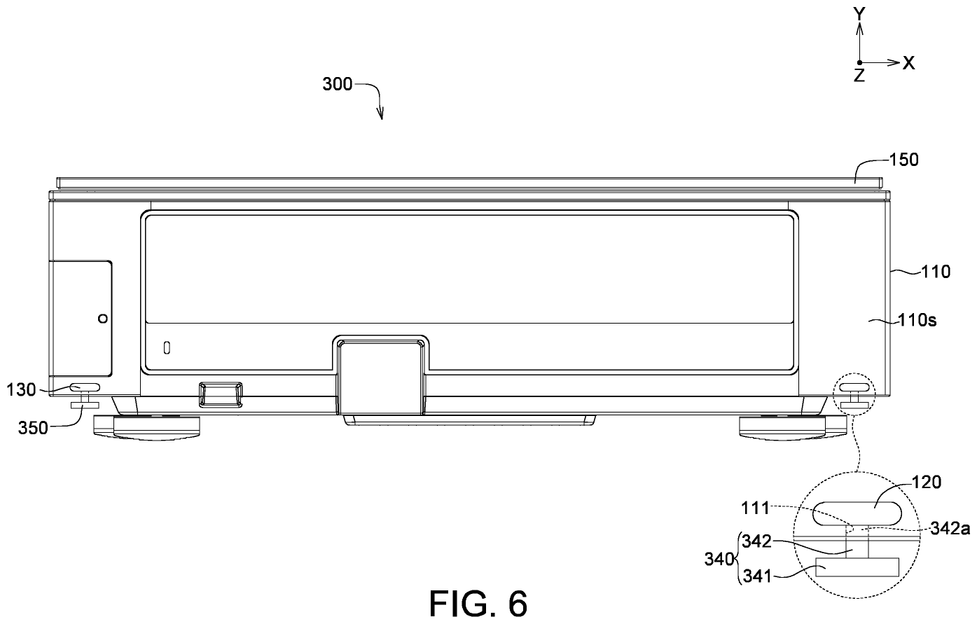

Referring to FIG. 6, a schematic diagram of a projector 300 according to another embodiment of the invention is shown. The projector 300 includes a projector body 110, a first positioning member 120, a second positioning member 130, a first fixing member 340, a second fixing member 350, a projection lens 140 (not illustrated) and a sliding cover 150. The projector 300 has technical features similar or identical to that of the projector 100 except for that the projector 300 further includes at least one fixing member, which fixes relative position between the projector body 110 and the positioning member or releases the fixed state between the projector body 110 and the positioning member.

For example, the first fixing member 340 is used to fix a relative position between the first positioning member 120 and the projector body 110. The first fixing member 340 is partly protruded from the body surface 110s (not illustrated in FIG. 6 due to the view angle), such that the user can conveniently touch and rotate the first fixing member 340 to fix the relative position between the first positioning member 120 and the projector body 110 or release the fixed state between the first positioning member 120 and the projector body 110. As indicated in FIG. 6, the first fixing member 340 includes a first terminal portion 341 and a first screwing portion 342 (such as male screw), wherein the projector body 110 has a second screwing portion 111 (such as female screw) screwed with the first screwing portion 342 and causes the terminal portion 342a of the first screwing portion 342 to selectively press the first positioning member 120 or release the first positioning member 120. The second fixing member 350 is used to fix a relative position between the second positioning member 130 and the projector body 110. The second fixing member 350 has a structure similar or identical to that of the first fixing member 340, and the similarities are not repeated here. Also, the connection relationship between the second fixing member 350 and the projector body 110 is similar or identical to that between the first fixing member 340 and the projector body 110, and the similarities are not repeated here.

Besides, the features and/or connection relationship of other elements of the projector 300 are similar or identical that corresponding features of the projector 100, and the similarities are not repeated here.

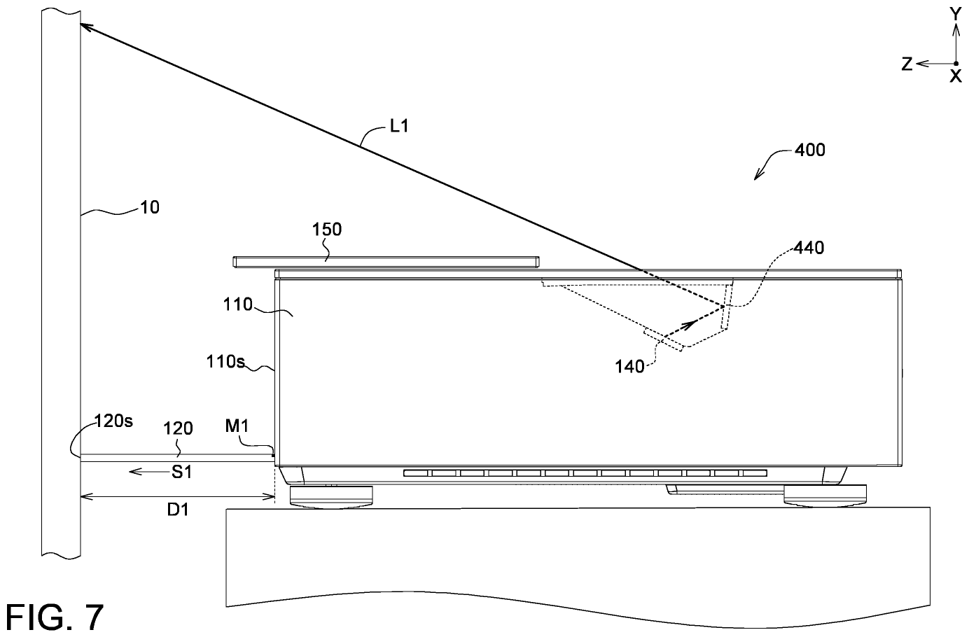

Referring to FIG. 7, a schematic diagram of a projector 400 according to another embodiment of the invention is shown. The projector 400 includes a projector body 110, a first positioning member 120, a second positioning member 130 (not illustrated), a first fixing member 340, a second fixing member 350, a projection lens 140, a reflector 440 and a sliding cover 150. The projector 400 has technical features similar or identical to that of the projector 100 except for that the projector 400 further includes the reflector 440. The image light L1 projected from the projection lens 140 can be backwardly projected to the reflector 440, which then forwardly s the image light L1 to the projection target 10 to form a picture (not illustrated). The features and/or connection relationship of other elements of the projector 400 are similar or identical that corresponding features of the projector 100, and the similarities are not repeated here.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation to encompass all such modifications and similar arrangements and procedures.

What is claimed is:

1. A projector, comprising:
a projector body used to project a picture; and
a first positioning member slidably disposed on the projector body, wherein the first positioning member has a first scale used to keep the projector body and a projection target at a first predetermined distance, and the projector body projects a picture with a first size according to the first predetermined distance.

2. The projector according to claim 1, wherein the extending direction of the first positioning member and the projection direction of the projector body are co-directional, and the first positioning member has a first terminal surface; when the first terminal surface is aligned with the projection target, the first predetermined distance is substantially equivalent to the distance between the first terminal surface and the first scale.

3. The projector according to claim 1, further comprising:
a second positioning member slidably disposed on the projector body, wherein the second positioning member has a second scale used to keep the projector body and the projection target at the first predetermined distance.

4. The projector according to claim 1, wherein the first positioning member has a third scale used to keep the projector body and the projection target at a second predetermined distance, and the projector body projects a picture with a second size different from the first size according to the second predetermined distance.

5. The projector according to claim 3, wherein the first positioning member and the second positioning member are symmetric with respect to the middle position of the projector body.

6. The projector according to claim 3, wherein the first positioning member has a first terminal surface, the second positioning member has a second terminal surface, and the distance between the first terminal surface and the first scale is equivalent to the distance between the second terminal surface and the second scale.

7. The projector according to claim 3, further comprising:
a connecting member used to connect the first positioning member and the second positioning member.

8. The projector according to claim 7, wherein the first positioning member has a first terminal surface, the second positioning member has a second terminal surface, the connecting member has a third terminal surface, and the first terminal surface and the second terminal surface are substantially flush with the third terminal surface.

9. The projector according to claim 1, wherein the projector body has a first chute and a body surface, the first chute is extended into the projector body from the body surface; the first positioning member has a first terminal surface; when the first positioning member is at a close state, the first terminal surface is substantially flush with the body surface.

10. The projector according to claim 1, further comprising:
a first fixing member used to fix a relative position between the first positioning member and the projector body.

11. The projector according to claim 10, wherein the projector body has a body surface from which the first fixing member is partly protruded.

12. The projector according to claim 10, wherein the first fixing member comprises a first terminal portion and a first screwing portion; the projector body has a second screwing portion; the first screwing portion is engaged with the second screwing portion and causes the terminal portion of the first screwing portion to selectively press the first positioning member or release the first positioning member.

13. The projector according to claim 1, the first terminal surface is a planar surface or a curved surface.
